(19) United States
(12) Patent Application Publication
(10) Pub. No.: US 2015/0163393 A1
(43) Pub. Date: Jun. 11, 2015

(54) REMOTE CONTROL BUILT-IN DEVICE CASE FOR ELECTRONIC DEVICE

(71) Applicant: jWIN ELECTRONICS CORP., PORT WASHINGTON, NY (US)

(72) Inventor: JUSTIN CHIWON KIM, GREAT NECK, NY (US)

(21) Appl. No.: 14/159,139

(22) Filed: Jan. 20, 2014

Related U.S. Application Data
(60) Provisional application No. 61/913,025, filed on Dec. 6, 2013.

(51) Int. Cl. H04N 5/232; H04B 1/3888; H04B 1/034; H04W 4/00

(52) U.S. Cl. CPC H04N 5/23206; H04W 4/008; H04B 1/3888; H04B 1/0346

(57) ABSTRACT

A device case for an electronic device such as a smartphone or tablet includes a detachable remote controller, or remote key, for controlling a camera and other features for the electronic device. The remote key can control the camera and other features via wireless communication protocols such as Bluetooth® protocols, Wi-Fi, or Infrared. The remote key can include various controls, which may be accessible to control the features while the key is attached or detached from the case. The device case can be designed to enable the remote key to be detached and reattached without having to destroy the device case or the remote key. By enabling the non-destructive detachment of the wireless control of the camera feature, a user may take a picture or video with the device's camera a distance away from the device while continuing to protect the device.

### CROSS-REFERENCE TO RELATED APPLICATION

The present application claims the benefit of U.S. Provisional Application Ser. No. 61/913,025, filed Dec. 6, 2013, which is hereby incorporated by reference herein in its entirety, including any figures, tables, or drawings.

### BACKGROUND

Many mobile electronic devices, such as cellphones or smartphones, often include various built-in features in addition to telephone capabilities. The inclusion of cameras and other features into mobile devices reduces the number of devices that a person must carry and provides additional functionality and capabilities for the mobile device. Unfortunately, it can be difficult to take a self-portrait or other picture or use other features in which the camera is to be spaced a distance farther than an arm's-length from the person using a mobile device. In addition, even when the user is fine with a distance of an arm's length, the user may find it difficult to use or control features such as the camera or other flashlight through a touch screen interface when holding the electronic device with one hand.

Built-in features, like cameras, flashlights, game controls, and writing/recording abilities, often include a variety of associated controls for operating the features. For example, zoom, lighting control, and flash options are often available for mobile device cameras. Other controls like on/off buttons, directional movement, and volume controls can be available for gaming or writing/recording features. It is not uncommon for mobile devices to also be able to obtain video in addition to still photographs. Thus, there can also be additional controls required for adjusting zoom, lighting, sound and other options pertaining to video recording.

The ability to utilize these features without having direct contact with the mobile device can be a helpful improvement. The further ability to activate and control these features wirelessly or by voice activation would be a significant improvement to mobile devices.

### BRIEF SUMMARY

A device case for an electronic device facilitating remote control of various features, including a camera, gaming, flashlight, or recording/writing features of the electronic device is described. A remote controller, in the form of a detachable remote key, can be built into a device case for an electronic device, so that users may control the camera or other features or options of the electronic device via controls on the remote key.

The remote key can be built into a device case for any electronic device including smart phones, tablets, phablets, and slate devices. The remote key can be detached and reattached from the device case easily and non-destructively, so that the user may control various features or options of the mobile device with the remote key when it is separated from the device case and the electronic device.

The remote key can include various types of feature controls thereon to access and control mobile device features. It can also be programmed so that controls on the key, such as, for example, push buttons, toggle switches, slide buttons, microphone for voice activation or recording, and other types of controls, can be assigned to control any desired function of a particular feature. Thus, the remote key controls are programmable and can be changed to provide different control capabilities as the features or capabilities of the electronic device change or the needs of a user change.

Features operated remotely can be difficult to see and, if the electronic device is not in close proximity, it may be impossible to know whether a particular feature has been accessed or activated by the remote controller. In such instances, it can be helpful to know if the instructions from the remote controller were received by and acted on by the electronic device. Specific embodiments include features whereby the remote controller can receive a signal from the electronic device when a feature is activated and the remote controller can emit haptic feedback, such as vibration, or an auditory or visual cue, such as, for example, sound or light, detectable by a user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example block diagram of a device case for an electronic device with built-in remote key.

FIGS. 2A and 2B illustrate an example case implemented for a smartphone. FIG. 2A shows a front view and FIG. 2B shows a back view.

FIG. 3 illustrates action for detaching and reattaching an example built-in remote key to the device case.

FIGS. 4A-4H illustrate views of a device case with built-in remote key according to an example design. FIG. 4A shows a front view; FIG. 4B shows a top view; FIG. 4C shows a bottom view; FIG. 4D shows a left view; FIG. 4E shows a right view; FIG. 4F shows a back view; FIG. 4G is a back perspective view; and FIG. 4H is an exploded back perspective view.

FIG. 5 illustrates a block diagram of an alternative example of a device case for an electronic device with built-in remote key capable of receiving a signal from an electronic device and emitting a signal or haptic response.

FIG. 6 is a block diagram of an alternative embodiment of a built-in remote key having input and output capabilities.

FIGS. 7A and 7B illustrate an alternative example of an electronic device case implemented for a smartphone. FIG. 7A shows a front view and FIG. 7B shows a backside view.

FIG. 8 is a bottom end, backside perspective view of an alternative example of an electronic device case, showing how the remote key fits flush into the case.

FIG. 9 is a bottom end, backside perspective view of the electronic device case, as shown in FIG. 8, with the remote key removed from the case by sliding from a recess in the case. Also shown are various controls and features that can be included on a remote key.

### DETAILED DISCLOSURE

A device case for an electronic device, such as a smartphone, phablet, or tablet, is described that includes a detachable remote controller for operating from a distance various features, like a camera feature, of an electronic device. A remote controller can be formed as an integral part of the device case, such that when it is attached to the device case it forms a part of the device case, and is referred to herein as a remote key. The terms remote controller and remote key are used interchangeably herein.

The remote key can control the camera or other features via wireless communication protocols such as Bluetooth® protocols, Wi-Fi, or Infrared. In one embodiment, the remote key includes one or more button controls, which may be accessible to control the electronic device features while attached or detached from the case. In another embodiment, the remote key can include a microphone. In a further embodiment, the microphone can be used to voice activate and control the electronic device features. The microphone can also be used to send information to a recording and/or writing feature, available on many mobile electronic devices. In a specific embodiment, the microphone is operably connected to voice recognition software that communicates with the electronic device when the voice(s) or the correct voice(s) is recognized.

The device case can be designed to enable the remote key to be detached and reattached without having to destroy the device case or the remote key. By enabling the non-destructive detachment of the wireless control feature of the device, a user may, for example, take a picture or video with the device's camera, operate a flashlight, activate a recording or writing feature, or control a game from some distance away from the device while the case continues to protect the device.

In some implementations, the device case can be a hard shell protective case. In some other implementations, the device case can be a soft shell protective case. To minimize the likelihood of a user misplacing the remote key, the device case not only provides a receptacle for the remote key, but enables use of the controller (i.e., the remote key) while it is safely attached to the device case.

In addition, the remote key can appear, when attached to the device case, as part of the device case, minimizing the bulkiness that could be attributed to scenarios in which the remote key was merely attached onto a case or inserted into a compartment of the device case.

In certain implementations, the device case itself can be considered a wireless controller of the features of the mobile electronic device, and the wireless controller portion of the device case can be detachable for use remotely from the electronic device and main portion of the device case thereon.

The remote controller (or remote key) can be configured to communicate with one or more features of the mobile electronic device through exposed functionality of the operating system of the mobile electronic device or through other applications that may be executed or running on the mobile device that enable access to and control of one or more of the features on the mobile electronic device, such as, but not limited to, a camera (for video or still pictures), gaming, flashlight, and recording or writing features. In another embodiment, the remote key can also receive one or more signals from the electronic device indicating that a particular feature has been activated or has been placed under control of the remote key. In a further embodiment, the received signal can trigger a cue, such as a haptic feedback, visual, or auditory signal that alerts a user that the particular feature has been activated or is under the control of the remote key.

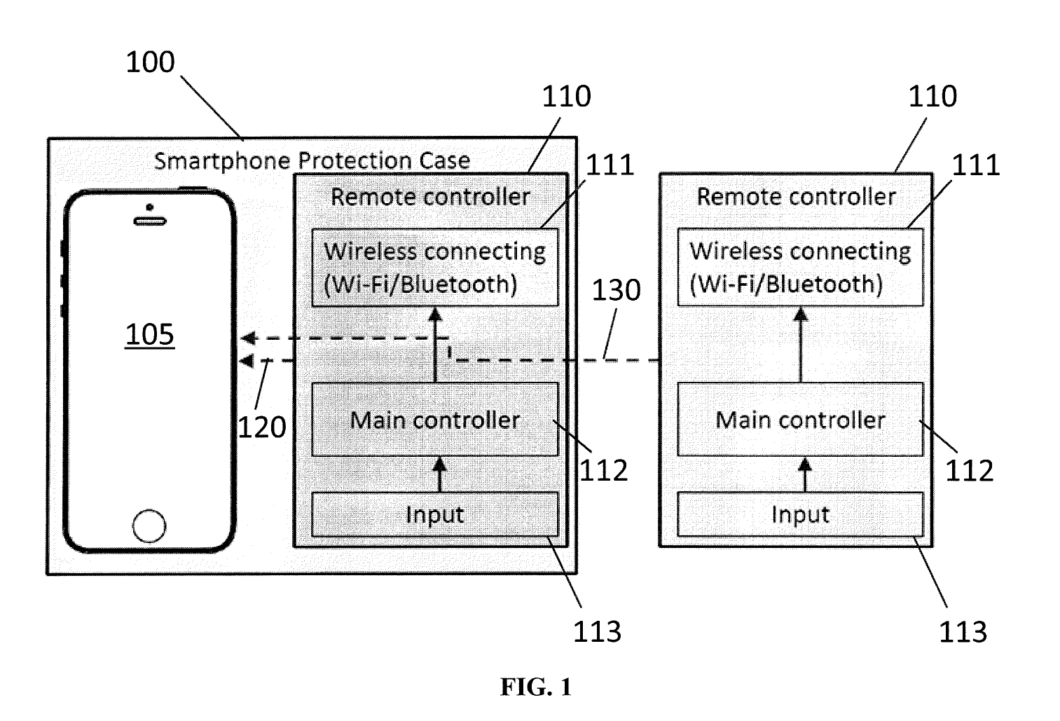

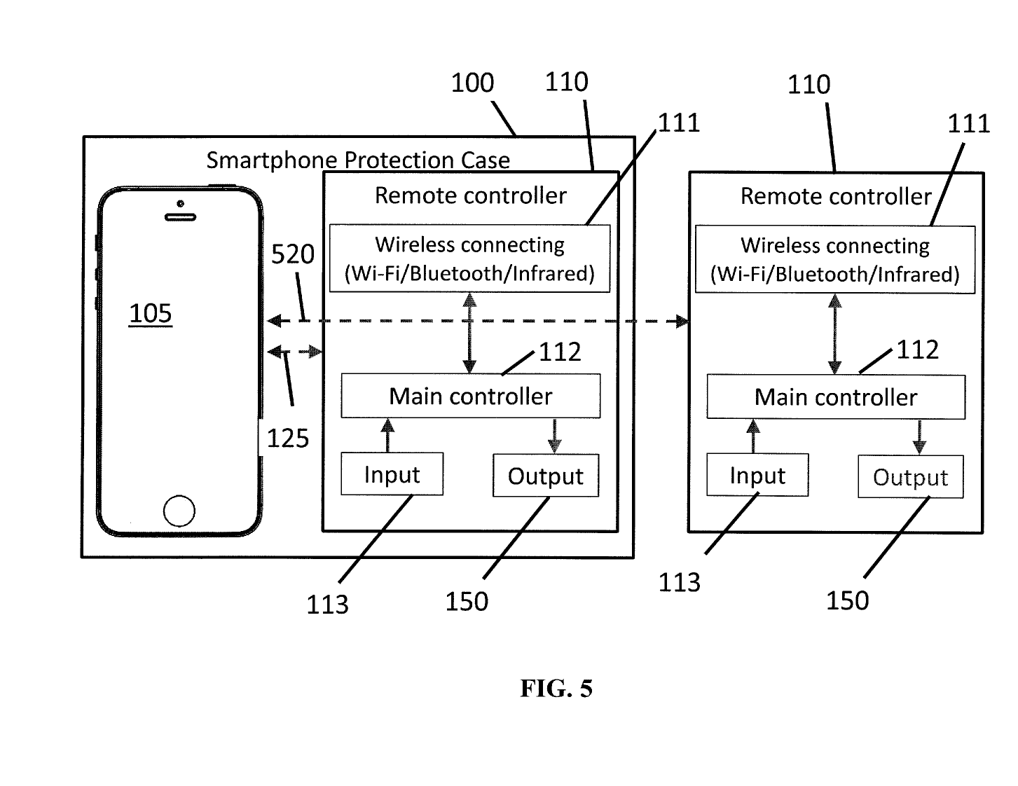

FIG. 1 illustrates an example block diagram of a device case for an electronic device with built-in remote key. As shown in FIG. 1, a device case 100 for an electronic device 105, such as, for example, a smart phone, can include a remote controller 110 for external control of one or more features, such as, for example, a camera feature, of the electronic device 105. FIG. 5 illustrates a block diagram of an alternative embodiment of a device case for an electronic device 105 also with a built-in remote controller. As shown in FIG. 5, a device case 500 can include a remote controller or remote key 510 for external control of one or more features on an electronic device 105. The term electronic device is used here generically to refer to any type of device that can be used with a protective cover and refers, in particular, to mobile electronic devices. Thus, it should be understood that a device case of the subject invention may be suitable for cell phones, smartphones, phablets, or tablets, including but not limited to, the iPhone®, iPad®, BlackBerry®, Samsung Galexy Note®, and Android® smartphone and other similar types of devices.

The remote controller 110 can control the features via a wireless connection, for example, a WiFi transceiver (or infrared connector) 111. The wireless connection can also be made according to Bluetooth® protocols, which are suitable and known to most mobile devices. The transceiver 111 can communicate with the electronic device 105 under the control of a main controller 112, which can be actuated by an input device 113, such as, for example, a button or microphone. Thus, when a user presses a button, uses a microphone, or provides some other suitable input with an input device 113 via the remote controller 110, the main controller 112 can control the wireless connecting device (e.g., the transceiver 111) to send a control signal 120 to the electronic device 105. The remote controller 110 can be detachable, such that when the remote controller 110 is separate from the protective case, the one or more controls, such as a push button, toggle switch, slide switch, or microphone, can be used to as input devices 113 to provide some suitable input via the remote controller 110 to output the wireless signal 130 from a distance.

FIG. 5 illustrates a further embodiment where the remote controller 110 has multiple input devices 113, including, but not limited to, buttons and a microphone. In a further embodiment, the microphone is operably connected to a voice recognition processor 114 through which voice command signals are transmitted to the main controller 112. Signals received by the main controller 112 from the various input devices 113 are received by the input signal mapping processor 116. The input signal mapping processor can then distinguish between the input signals 115 received from the input devices 113 and determine which features or applications are associated with each signal 115 and how the feature or application is to be controlled by the input signal 115. The input signal mapping processor 116 can then send mapped information 118 to the main processor 540 in the main controller 112. The main processor 540 then transmits a control signal 120 to the electronic device through the transceiver 111 to operate the feature on the electronic device.

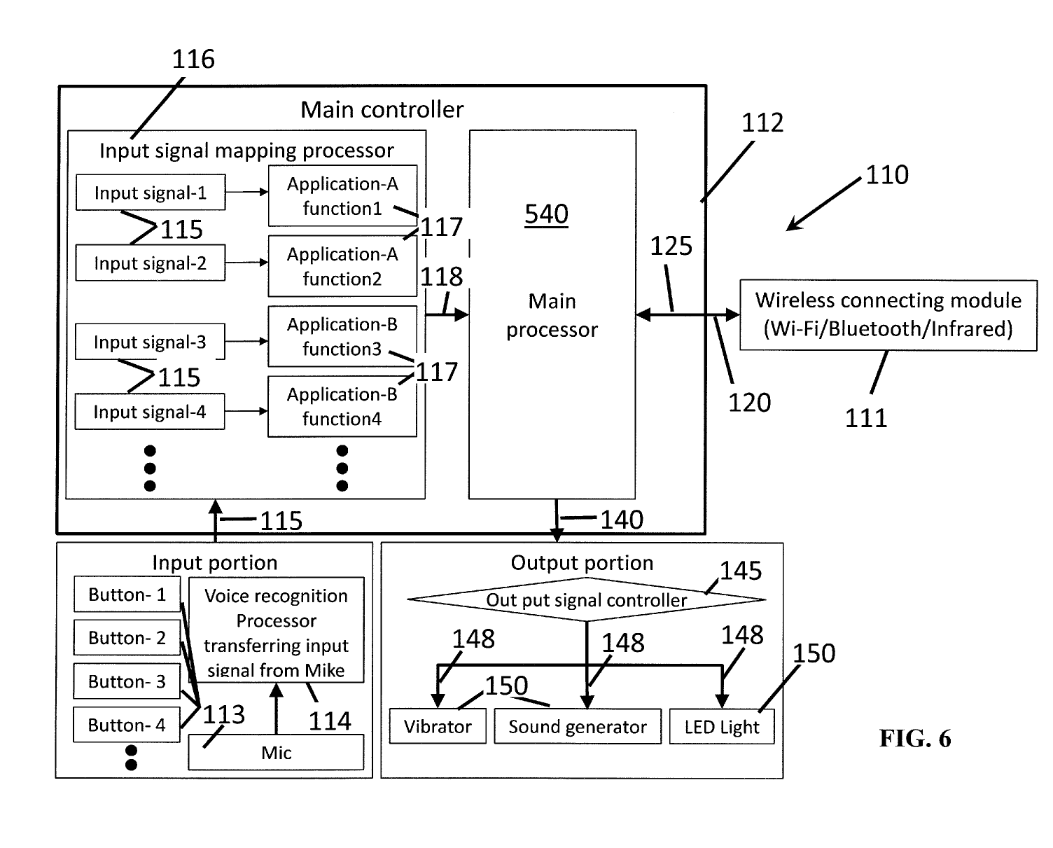

In a further embodiment, the electronic device 105 can transmit a reply signal 125 to the transceiver 111. The reply signal 125 can indicate that the control signal 120 was received by the electronic device. This can require the reply signal 125 to be sent to the main processor 540, which can interpret and translate the reply signal 125 into an output signal 140 and send it to an output signal controller 145. In one embodiment, the remote controller 110 has one or more audio, visual, or haptic output indicators 150. FIG. 6 illustrates an example of this embodiment. The output signal controller 145 can receive the output signal 140 and generate an appropriate indicator signal 148. When activated by the indicator signal 148, an output indicator 150 operably connected to the output signal controller 145 can inform a user that the particular control signal 120 was received by the electronic device 105. By way of non-limiting example, an output indicator can be a haptic device, such as a vibrator 151, placed within the remote controller. When the vibrator 151 receives the indicator signal 148 from the output signal controller 145, it generates a vibration that can be detected by the user and indicates that a particular control has been activated. Thus, the cue indicates that the electronic device received the particular command associated with the input device 113 that was used.

In a further embodiment, there can be more than one and more than one type of output indicator. In specific embodiment, shown, by way of example, in FIG. 6, a remote controller can have multiple output indicators of different types, such as, but not limited to, a vibrator, sound generator, e.g., speaker, and LED light. In a further embodiment, each output indicator can be associated with a specific input signal 115. In this way, different input signals 115 can ultimately result in different indicator signals 148 being sent to one or more output indicators 150 with each signal being indicative of a different control being activated or used.

In another embodiment, an output indicator 150 can generate more than one cue. In one embodiment, an output indicator can be linked to more than one specific output signal 148, such that different output signals sent to the same output indicator can provide different responses by the output indicator. For example, one output signal 148 sent to an LED light might generate a slow blink rate indicating that one control was activated on the electronic device, whereas a different output signal sent to the same LED light might generate a faster blink rate, indicating that a different control was activated on the electronic device. By way of further example, the remote controller can have a speaker that generates different sounds depending upon the type of output signal 148 received. In this way, the remote controller can have fewer output indicators but still provide a range information in the form of cues to a user indicating the state and operation of the electronic device.

In a further embodiment, the electronic device can include a feature that would activate an output indicator on the remote controller. In one embodiment, an application on the electronic device can be activated to send a signal to the remote control that activates the output indicator. Alternatively, the device case can have a button or other activation device that causes an output indicator to be activated. Preferably, the output signal is a sound. But, any of the output indicators on a remote controller could be utilized. In the event that the remote controller is lost, the output indicator can be activated to assist in locating the remote controller.

Thus, a wireless connector 111 can be detachably installed in the protective case 110 so that features of the electronic device 105 can be controlled from a distance.

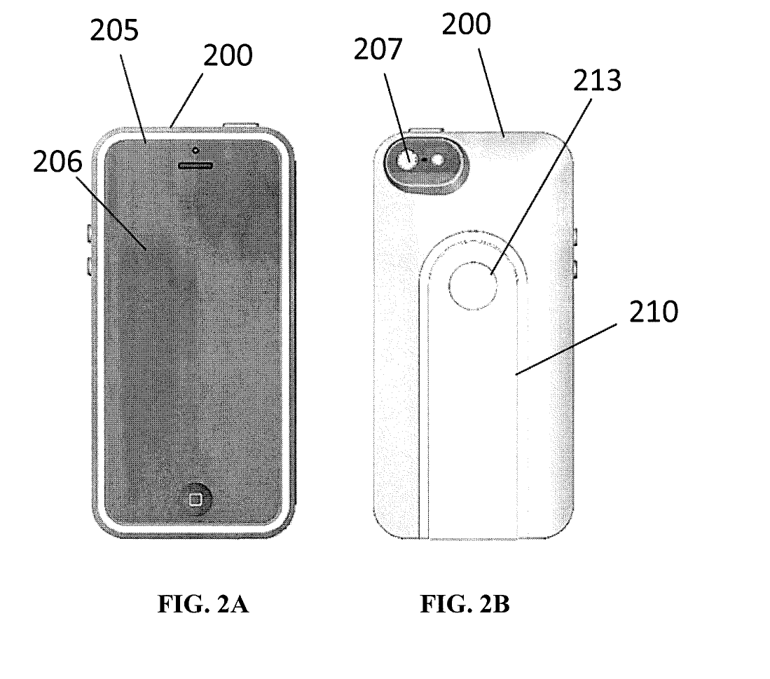

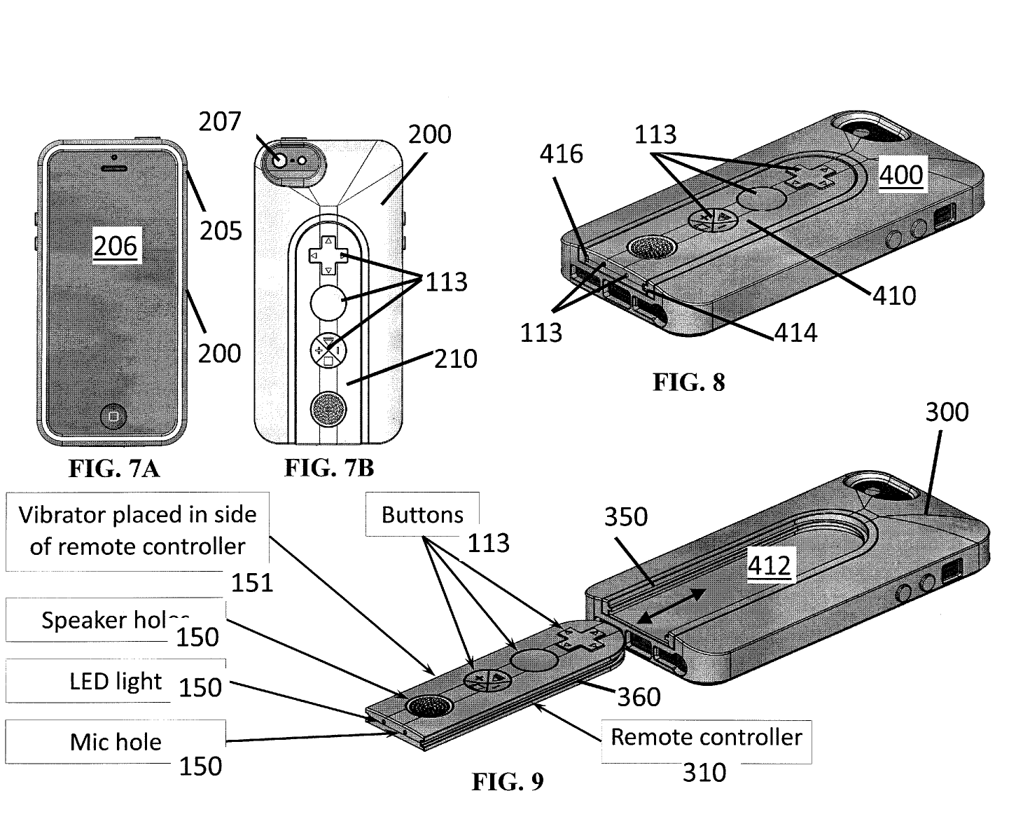

FIGS. 2A, 2B, and 7A and 7B illustrate example cases implemented specifically for a smartphone. As shown in FIGS. 2A and 7A, the device case can be form-fitting to the smartphone. For example, a case 200 may fit snuggly around a smartphone 205 while exposing the touch screen 206 of the smartphone 205 on the front side and the lens 207 for the camera on the back side. The remote controller can be a remote key 210 that is formed to fit as part of the case 200. One or more input devices 113, such as a button 213, speaker, toggle, slide or push switch, etc. can be used for wirelessly controlling a camera or other features of the smartphone 205 and can be available while the remote key 210 is attached to the protective case 200.

As an example, when taking a picture or video with a built-in camera of any mobile device, a button 213 can be pressed on the remote controller 210, which is attached to the device case 200 on the mobile device 205. The device case 200 is mechanically designed in such a way that the wireless remote controller (remote key 210) can be detached and reattached, allowing pictures or videos to be taken by using the remote controller (remote key 210) while the remote controller (remote key 210) is attached or detached from the case 200.

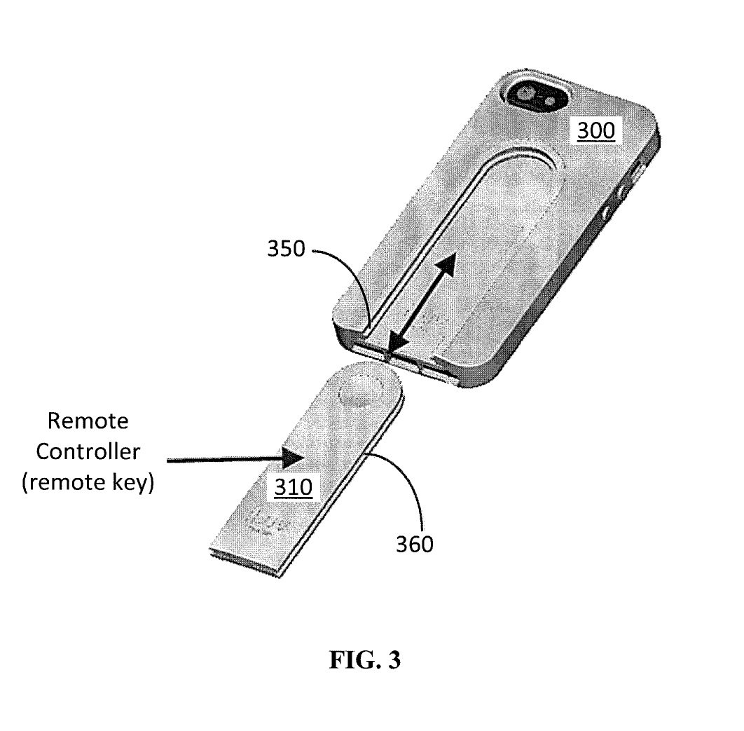

FIGS. 3 and 9 illustrate the action for detaching and reattaching an example built-in remote key to the device case. As illustrated in FIGS. 3 and 9, while the device case 300 is on the electronic device, the remote key 310 can be slidably attached and detached using, for example, a protruding rib 350 and matching groove 360. It should be understood that while a rib and groove are shown, other mechanisms may be used. In addition, the key may have a rib while the recess of the case may have a groove and/or multiple ribs and grooves may be used on one or both of the elements.

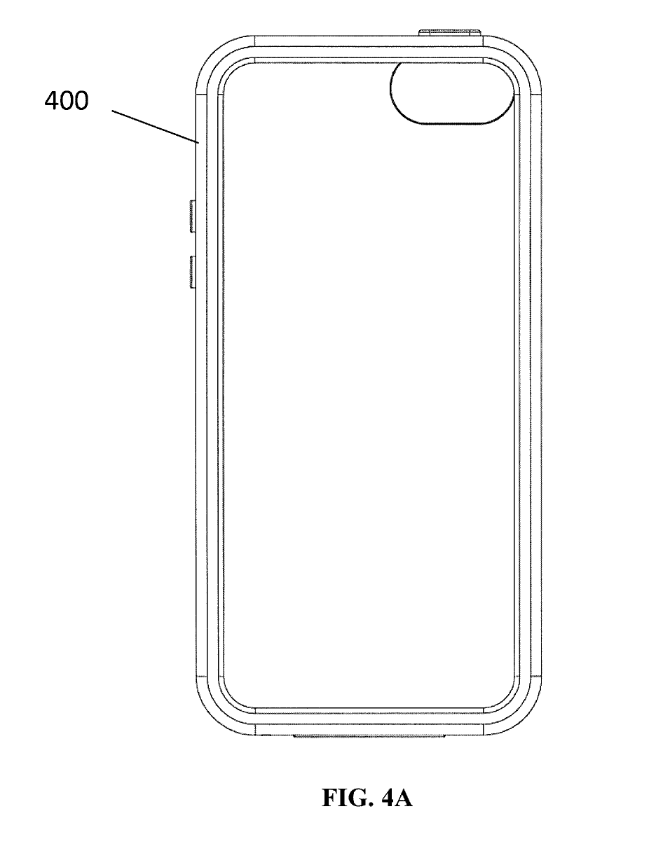

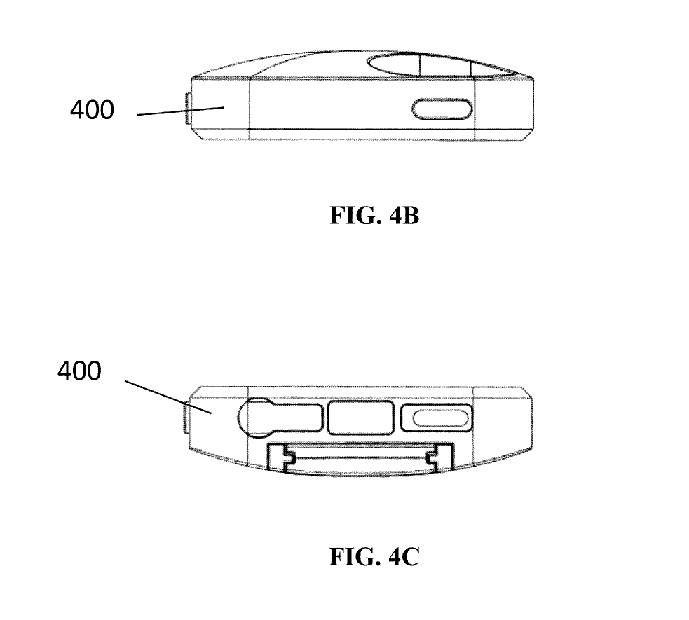

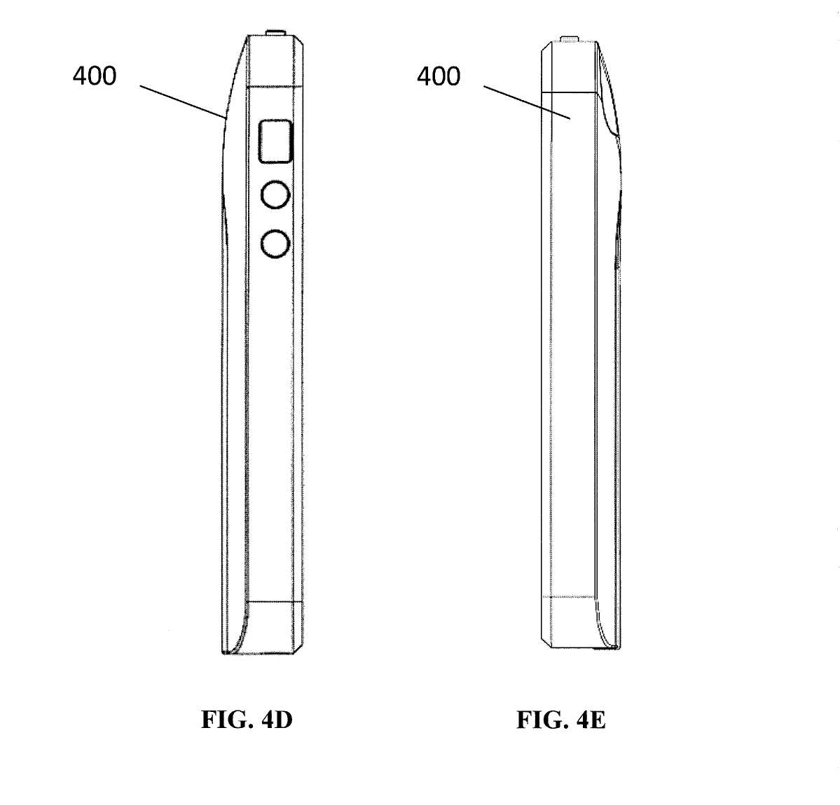

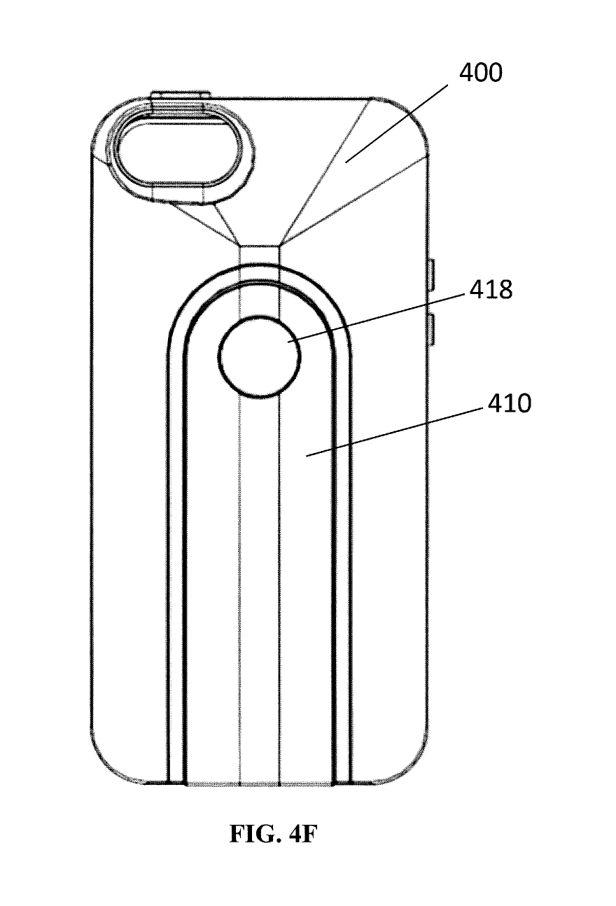

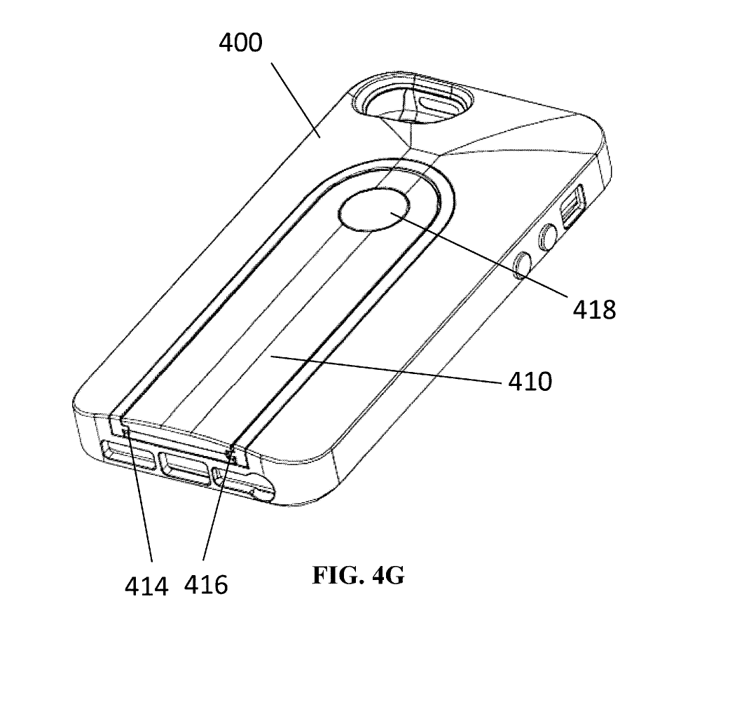

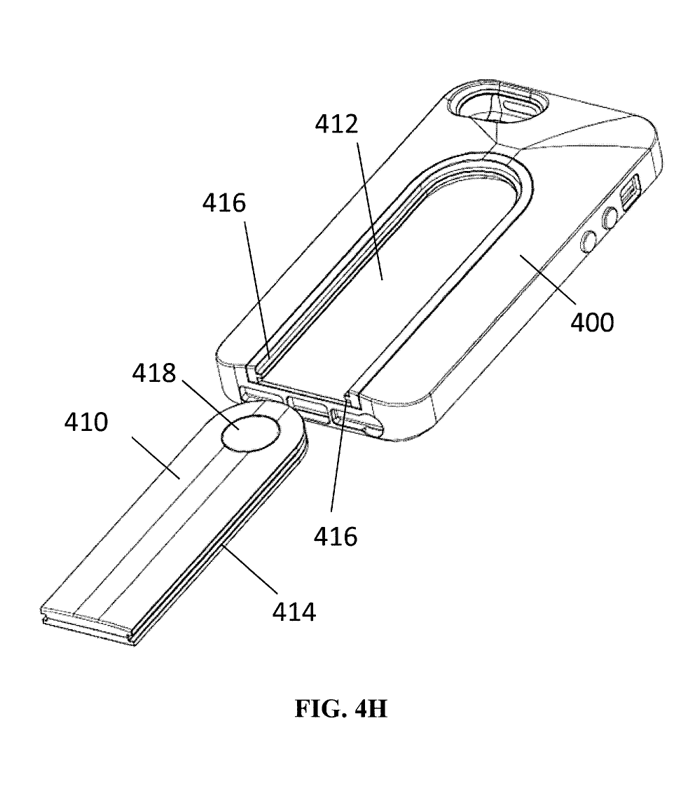

FIGS. 4A-4H and 8 illustrate views of a case 400 with a built-in remote key 410 that may be suitable for a smartphone or other mobile device having a front side touch screen (e.g., touch screen 206 of FIG. 2A) and at least a first camera lens at a back side top corner (e.g., lens 207 of FIG. 2B). It should be understood that the remote key 410 and device case 400 are suitable for mobile devices having a camera lens on a front side in addition to or in place of the camera lens on the back side. In the example illustrated in FIGS. 4F, 4G, 4H, 8, and 9, the remote key can be thin (may appear flush from a side view) and can slide into a ribbed recess 412 from a bottom of the device case 400. The remote key 410 can have a tab shape with a groove 414 corresponding to the rib protrusion 416 along the interior of the recess 412 to which the key 410 slides. One or more input devices 113, such as a button 418 for controlling the camera or other features of the mobile device can be accessible while the remote key 410 is detachably secured in the ribbed recess 412.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

1. A device case for containing an electronic device having at least one feature, the device case comprising:
a remote controller housed within and detachable from the case, the remote controller comprising:
a wireless connector for remotely connecting to the mobile device to control the feature; and
at least one input device operably connected to the wireless connector, such that activation of the input device controls an operation of the feature.

2-8. (canceled)

9. The device case according to claim 1, wherein the at least one feature is one or more of a camera, flashlight, game, video recorder, voice recorder, and writing recorder.

10. The device case according to claim 9, further comprising:
at least one output indicator operably connected to the wireless connector, such that activation of the input device causes the output indicator to generate a signal indicative of activation of a control for a feature.

11-12. (canceled)

13. The device case according to claim 10, wherein one or more of an input device is programmable by a user to control a specific feature on the mobile device.

14-16. (canceled)

17. A case system for containing an electronic device having a screen interface and a camera feature, the case system comprising:
a case body configured to receive and at least partially encase the electronic device, the case body having one or more openings, the openings adapted to expose at least one lens associated with the camera feature and at least a substantial portion of the screen interface, the case body also having a recess configured to removably secure a remote key;
the remote key comprising:
a wireless connector configurable to provide wireless communication between the remote key and the electronic device to allow control of the camera feature;
a control on the remote key operatively connected to a main controller; and
the main controller being operably connected to the wireless connector and the control, the main controller being adapted to cause the wireless connector to send a signal to the electronic device to control the camera feature upon operation of the control; and,
the recess and the remote key being configured such that the remote key is partially enclosed within the case body in an encased mode of operation, the control being exposed and operable to operate the camera feature while the remote key and the case body are in the encased mode of operation;
the remote key being removable from the case body in a detached mode of operation, the control being operable, when detached, to operate the camera feature in the detached mode of operation, the remote key being detached from the case body in the detached mode of operation.

18. The case system of claim 17, wherein in the detached mode of operation the case body continues to at least partially encase and protect the electronic device.

19. The case system of claim 17, wherein the remote key and recess are formed such that in the encased mode of operation the remote key fits substantially within the form factor of the case body.

20. The case system of claim 19, wherein remote key and recess are formed such that in the encased mode of operation the remote key is substantially flush with a surface of the case body.

21. The case system of claim 17, wherein the remote key can be detached from and reattached to the case body without substantially affecting the ability of the case body to protect the electronic device.

22. The case system of claim 17, wherein the control comprises a tactile input and wherein, in the detached mode of operation, the remote key can be separated from the case body such that operation of the control does not cause movement of the case body.

23. The case system of claim 22, wherein the control comprises one or more of a push button, toggle switch, or slide switch.

24. The case system of claim 17, wherein the control comprises a microphone.

25. The case system of claim 17, wherein:
the remote key further comprises an output device operably connected to the main controller;
the wireless connector is further configurable to provide wireless communication between the electronic device and the remote key; and
the main controller being further adapted to receive an output signal from the electronic device, via the wireless connector, and present the output signal via the output device.

26. The case system of claim 25, wherein the output signal provides feedback to a user, via the output device, that the camera feature has been operated.

27. The case system of claim 26, wherein the feedback comprises one or more of a sound, light, or vibration.

28. The case system of claim 27, wherein the output device comprises a speaker, lamp, or vibrator.

29. The case system of claim 17, wherein the main controller is programmable such that the control can be used to operate one or more additional features of the electronic device.

30. The case system of claim 17, wherein the remote key comprises one or more additional input devices operably connected to the main controller and main controller is programmable such that the one or more additional input devices can be used to operate one or more additional features of the electronic device.

31. The case system of claim 29, wherein the one or more additional features comprise one or more of a flashlight, game, video recorder, voice recorder, and writing recorder.

32. A case system for containing an electronic device having a screen interface, the case system comprising:
a case body configured to receive and at least partially encase the electronic device, the case body having one or more openings, the openings adapted to expose at least a substantial portion of the screen interface, the case body also having a recess configured to removably secure a remote key;
the recess and the remote key being configured such that the remote key is partially enclosed within the case body in an encased mode of operation and removable from the case body in a detached mode of operation;
the remote key comprising:
a wireless connector configurable to provide wireless communication between the electronic device and the remote key; and
an output indicator adapted to receive an output signal from the electronic device, via the wireless connector, and present the output signal to a user to allow location of the remote key.
